(19) United States
(12) Patent Application Publication
(10) Pub. No.: US 2024/0059337 A1
(43) Pub. Date: Feb. 22, 2024

(54) SHOPPING CART SEAT CUSHION

(71) Applicant: Ray G. Foster, Mount Dora, FL (US)

(72) Inventor: Ray G. Foster, Mount Dora, FL (US)

(21) Appl. No.: 18/453,692

(22) Filed: Aug. 22, 2023

Related U.S. Application Data
(60) Provisional application No. 63/399,801, filed on Aug. 22, 2022.

(51) Int. Cl. B62B 3/14; A47D 15/00

(52) U.S. Cl. CPC B62B 3/1448; A47D 15/00

(57) ABSTRACT

A seat cushion for a shopping cart is provided. The seat cushion includes a cushion panel designed to be placed in the seat portion of the shopping cart. The cushion panel has an interior pad and a cover that is positioned on top of the interior pad. The cushion panel is capable of being selectively moved between a folded position and an unfolded position. This allows for convenient storage and deployment of the seat cushion as needed. The seat cushion provides enhanced comfort and support for users of the shopping cart, improving their overall shopping experience.

### CROSS REFERENCE TO RELATED APPLICATIONS

This application claims the benefit of U.S. Provisional Application Ser. No. 63/399,801, filed on Aug. 22, 2022. The entire disclosure of the above application is incorporated herein by reference.

### FIELD

The present technology relates to cushions, and more particularly, a cushion for a shopping cart.

### INTRODUCTION

This section provides background information related to the present disclosure which is not necessarily prior art.

Transporting infants and small children on a shopping trip to a grocery store or similar retail enterprise often involves the use of a shopping cart that is constructed with a folding or collapsible child seat situated proximate to the push handle of the shopping cart. These child seats are designed essentially to support an infant or small child in an upright position within the shopping cart with few if any features designed to provide for the comfort or hygiene of the infant or small child.

A typical shopping cart is generally manufactured of materials that satisfy the requirements of relatively low acquisition and manufacturing cost, durability, and high strength, such as metal rods, molded plastic components, and the like. The particular characteristics of such materials that allow them to meet these requirements, such as rigidity, do not provide a particularly comfortable seating surface in the case of the child seat.

This situation is especially acute in the case of shopping carts manufactured of metal rods spaced at predetermined intervals, in which case the limbs, posterior, or back of the infant or small child seated therein press against one or several of such individual rods. The child reacts by squirming within the seat in an attempt to reduce bodily contact with the seat or by attempting to leave the seat altogether. This occurrence can be especially troublesome to a parent or guardian who is attempting to accomplish a sizable shopping chore.

One means of providing a more comfortable seating device for a child within a shopping cart is the provision by the retailer of a child safety seat that can be attached, adjusted or otherwise used in conjunction with a conventional shopping cart. Normally, such seats are manufactured of plastic and molded or constructed of a shape similar to a child safety seat for vehicles in which an infant or small child can be positioned in a generally recumbent position. As such child safety seats are used repeatedly by a wide variety of people and customers, it is inevitable that the child seats become soiled or contaminated by microbes, infectious agents, or spilled food stuffs that may make contact with the skin or clothing of an infant or small child later placed in the seating device and engender a reaction by or, infection of the infant or small child.

As such, it may be appreciated that there is a continuing need for a new and improved seat cover for a child safety seat for shopping carts that can be attached to and detached from a safety seat with minimum exertion and that furthermore provides a pleasing, comfortable seating surface for an infant or small child.

### SUMMARY

In concordance with the instant disclosure, an improved shopping seat cushion, has surprisingly been discovered.

The present invention relates to a seat cushion for a shopping cart. The seat cushion comprises a cushion panel designed to be placed in a seat portion of the shopping cart. The cushion panel includes an interior pad and a cover that is positioned on top of the interior pad. The cushion panel is capable of being selectively moved between a folded position and an unfolded position. This allows for convenient storage and deployment of the seat cushion as needed. The seat cushion provides enhanced comfort and support for an infant or small child seated in the seat portion of the shopping cart, improving their experience.

In one embodiment, a seat cushion for a shopping cart can include a cushion panel configured to be disposed in a seat portion of a shopping cart. The cushion panel can include an interior pad and a cover disposed on the interior pad. The cushion panel can be selectively movable between a folded and an unfolded position.

In another embodiment, a shopping cart seat cushion assembly can include a shopping cart having a seat portion. A seat cushion can be disposed on the seat portion of the shopping cart. The seat cushion can include a cushion panel, where the cushion panel can include an interior pad and a cover disposed on the interior pad. The cushion panel can be selectively movable between a folded and an unfolded position.

In a further embodiment, a method of using a shopping cart seat cushion can include providing a seat cushion in a folded position. The seat cushion can be unfolded and placed in a seat portion of a shopping cart. A user, such as an infant or small child, can be placed atop the seat cushion in the seat portion of the shopping cart.

The seat cushion can be utilized in a typical shopping cart. The seat cushion can be particularly well suited for a child, and more specifically, where the child is between the ages of one (1) and four (4) years. The seat cushion can be contoured and ergonomic for a young child. The seat cushion can enhance the comfort of the typical child seat of the shopping cart.

The seat cushion can be manufactured from a material that is non-toxic and non-irritating to a child's skin. The material can be breathable and non-woven. The material can be a soft, medium-tear flexible foam. The material can be stain-resistant, easy to clean, and lightweight for travel. The material can be waterproof and not absorb liquids or odors. Suitable materials can include those configured to be wiped clean and can include PVC free and phthalate free materials. In certain embodiments, the material can include a flexible polyurethane foam.

The seat cushion can have a shape and dimensions that allow the seat cushion to be utilized in a shopping cart. For example, the cushion can have a central cutout that allows the seat cushion to be inserted into the cart seat around a central bar of a child seat. The cushion can be 7 inches wide, 12 inches long, and ⅜^{th} of an inch thick, in one non-limiting embodiment.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a shopping cart seat cushion, according to one embodiment of the present disclosure;

FIG. 2 is a top plan view thereof;

FIG. 3 is a bottom plan view thereof;

FIG. 4 is a rear elevational view thereof;

FIG. 5 is a front elevational view thereof;

FIG. 6 is a right side elevational view thereof;

FIG. 7 is a left side elevational thereof;

FIG. 8 is a top perspective view of the shopping cart seat cushion, depicted in a partially folded position;

FIG. 9 is a top perspective view of the shopping cart seat cushion, depicted in a folded position;

FIG. 10 is a top plan view of the shopping cart seat cushion shown inserted into a shopping cart;

FIG. 11 is a top perspective view the shopping cart seat cushion shown inserted into a shopping cart; and

FIG. 12 is a flowchart depicting a method of using the shopping cart seat cushion, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

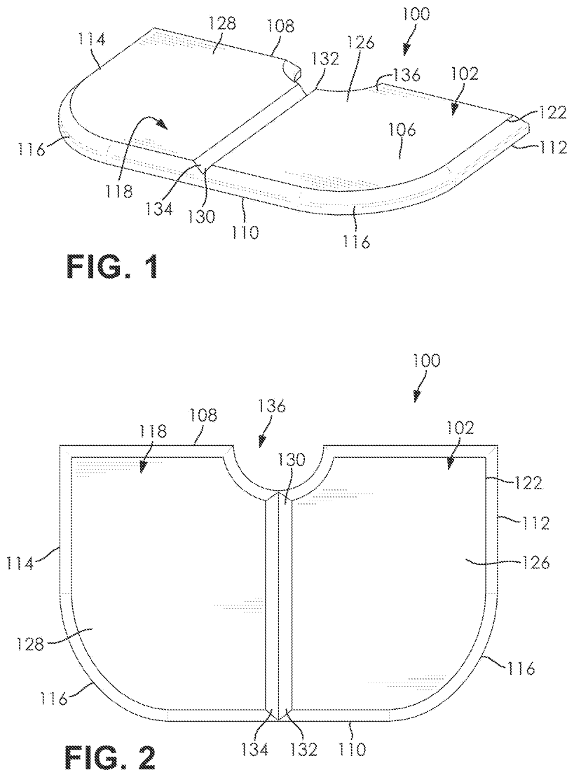

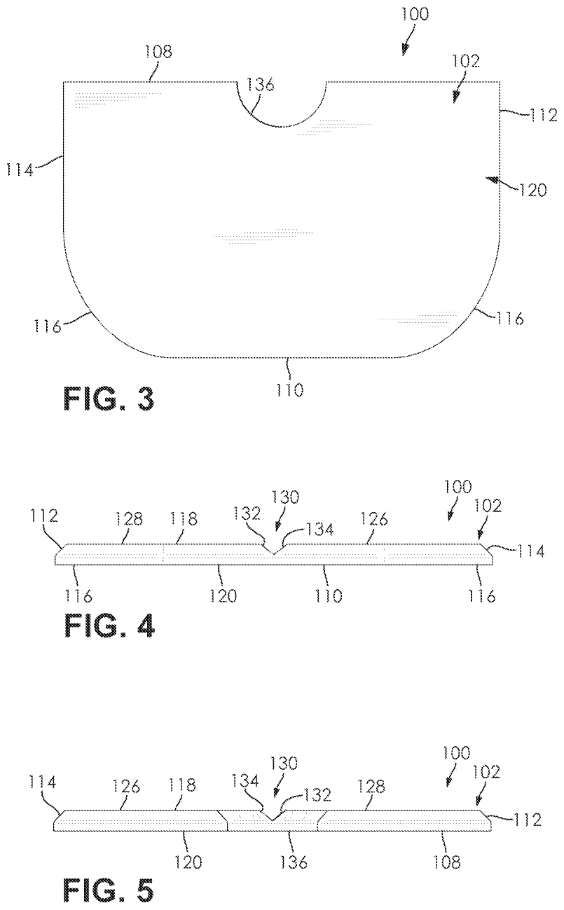

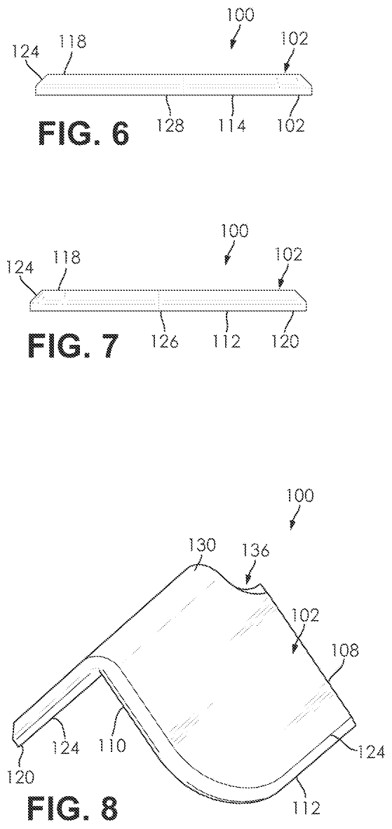

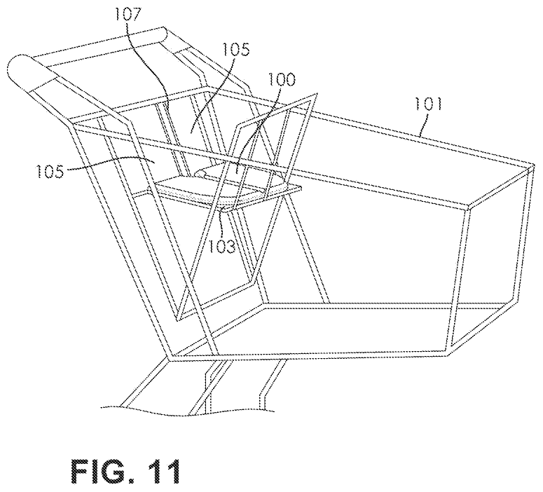

With reference to FIGS. 1-12, a seat cushion 100 for a shopping cart 101 is shown. The seat cushion 100 can include a cushion panel 102. The cushion panel 102 can be generally configured to be disposed in a seat portion of the shopping cart 101. The cushion panel 102 can include an interior pad 104 and a cover 106 disposed on or about the interior pad 104. For example, embodiments include where the cover 106 fits over a side of the interior pad 104 and where the cover 106 fits about and substantially or completely encloses the interior pad 104. It is also possible to have multiple covers 106 that can be installed on the interior pad 104 and/or where the covers 106 can be interchangeably fitted on the interior pad 104.

The interior pad 104 can be manufactured from a foam material. The material can be a soft, medium-tear flexible foam. The foam can include comfort foams, memory foams, low density foams and similar cushioning materials. In other embodiments, the interior pad 104 can be manufactured from rubber or plastic foams including polyurethane foam, ethylene-vinyl acetate foam, and combinations thereof. A skilled artisan can select a suitable material for the interior pad 104, within the scope of the present disclosure.

The cover 106 can be manufactured from a material that is non-toxic and non-irritating to skin of a user. The material can be breathable and non-woven. The material can be stain-resistant, easy to clean, and lightweight for travel. The material can be waterproof and militate against the absorption of liquids or odors. The material can be fast drying. The material can be substantially free of polyvinyl chloride (PVC) and phthalates. In one non-limiting embodiment, the material for the cover can be polyester.

The cushion panel 102 can be substantially rectangular in shape. In particular, the cushion panel 102 can have a length that is greater than width of the cushion panel 102. The rectangular shape of the cushion panel 102 can be defined by a first longitudinal side 108 and a second longitudinal side 110 disposed substantially parallel to one another. The first longitudinal side 108 and the second longitudinal side 110 can be connected via a third side 112 and a fourth side 114. The first longitudinal side 108 and the second longitudinal side 110 can each be disposed substantially transverse to each of the third side 112 and the fourth side 114. Each of the sides 108, 110, 112, 114 can have a height associated therewith.

In one non-limiting example, the cushion panel 102 can have a maximum length from about 10 inches to about 14 inches and can have a maximum width from about 6 inches to about 8 inches. In a most particular non-limiting example, the cushion panel 102 can have a maximum length of about 12 inches and can have a maximum width of about 7 inches.

As shown in FIGS. 1-2, where the second longitudinal side 110 meets each of the third side 112 and the fourth side 114, the cushion panel 102 can have a rounded corner 116. The rounded corners 116 can militate against damage to the cushion panel 102 in operation in the shopping cart 101. In particular, the rounded corner 116 can be more easily inserted into the seat of the shopping cart 101 without catching on any sharp metal edges present in the shopping cart 101.

The cushion panel 102 can further include a top surface 118 and a bottom surface 120. The top surface 118 and the bottom surface 120 can be substantially planar. The bottom surface 120 can be disposed substantially parallel to the top surface 118. The top surface 118 and the bottom surface 120 can be separated by the height of the cushion panel 102. The top surface 118 and the bottom surface 120 can be connected to each of the first longitudinal side 108, second longitudinal side 110, third side 112, and fourth side 114.

The top surface 118 can be circumscribed by a top edge 122. The bottom surface 120 can be circumscribed by a bottom edge 124. Each of the top edge 122 and the bottom edge 124 can be contiguous around an entire perimeter of the cushion panel 102. As shown in FIG. 1, the top edge 122 can be rounded. Similar to the rounded corners 116 described herein, the rounding of the top edge 122 can militate against damage to the cushion panel 102 in operation in the shopping cart 101.

In some embodiments, the bottom edge 124 can be formed in the cover 106 of the cushion panel 102. The cover 106 can be sealed at the bottom edge 124 via heat, stitching, or an adhesive, as non-limiting examples. It should be appreciated that the seal formed in the cover 106 can be substantially free of the interior pad 104. In this way, the cover 106 can fully enclose the interior pad 104. Advantageously, the cover 106 can militate against damage to the material of the interior pad 104 such as reducing physical wear on the material or militating against liquids seeping into the interior pad 104.

With reference to FIGS. 1-2, each of the first longitudinal side 108, the second longitudinal side 110, the third side 112, and the fourth side 114 can taper along the height from the top edge 122 to the bottom edge 124. Advantageously, the tapering of each of the first longitudinal side 108, the second longitudinal side 110, the third side 112, and the fourth side 114 can allow the cover 106 to be more tightly wrapped and sealed around the interior pad 104 during manufacture. Where foam material is used, the tapering of each of the first longitudinal side 108, the second longitudinal side 110, the third side 112, and the fourth side 114 can improve the structural integrity of the interior pad 104 by reducing strain on the foam material at each of the first longitudinal side 108, the second longitudinal side 110, the third side 112, and the fourth side 114, in operation.

With reference to FIGS. 1-2, the interior pad 104 of the cushion panel 102 can be bisected to form a first cushion panel 126 and a second cushion panel 128. In one embodiment, the interior pad 104 of the cushion panel 102 can be bisected along a central axis which extends from the first longitudinal side 108 to the second longitudinal side 110. The interior pad 104 of the cushion panel 102 can include a channel 130 formed along the central axis. The channel 130 can separate the first cushion panel 126 from the second cushion panel 128. Embodiments include where the cushion panel 102 is bisected by having a thinner portion at the channel 130 that can operate as a hinge between the first cushion panel 126 and the second cushion panel 128.

The channel can have a depth. The depth of the channel 130 can be less than the height of the cushion panel 102, for example, as shown in FIG. 5. In this way, the channel does not extend an entire height of the cushion panel 102, which allows the first cushion panel 126 and the second cushion panel 128 to remain connected within the cover 106. In one non-limiting embodiment, the channel 130 can have a depth of 6.5 mm and a width of 18 mm.

The first cushion panel 126 can include a first angled interior wall 132 and the second cushion panel 128 can include a second angled interior wall 134. The first angled interior wall 132 and the second angled interior wall 134 can define the channel 130. In particular, the first angled interior wall 132 can be angled downwardly towards the central axis from the top edge 122 to a lowest point in the channel 130. The second angled interior wall 134 can be disposed adjacent and opposite to the first angled interior wall 132. The second angled interior wall 134 can be angled downwardly towards the central axis from the top edge 122 to a lowest point in the channel 130. The first angled interior wall 132 and the second angled interior wall 134 can meet at the central axis. The first angled interior wall 132 and the second angled interior wall 134 can define a substantially V-shaped channel 130.

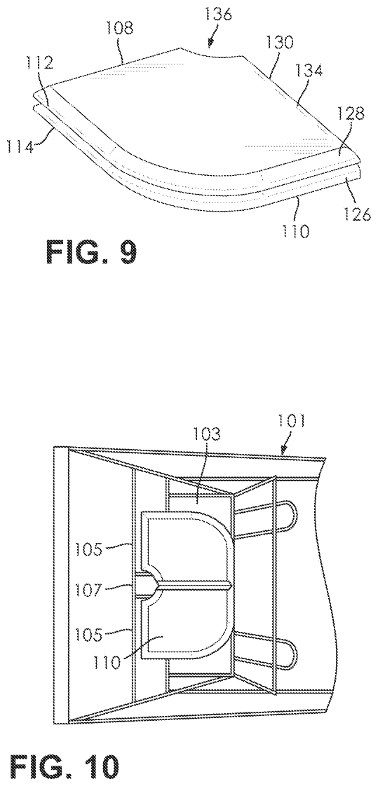

It should be appreciated that the channel 130 can allow the cushion panel 102 to be foldable at the channel 130 and about the central axis. In particular, the cushion panel 102 can be folded such that the bottom surface 120 of the first cushion panel 126 abuts the bottom surface 120 of the second cushion panel 128, for example, as shown in FIG. 9. Alternatively, embodiments include where the top surface 118 of the first cushion panel 126 abuts the top surface 118 of the second cushion panel 128. Accordingly, the cushion panel 102 can be selectively moveable between an unfolded position and a folded position. The unfolded position configured for use within the shopping cart 101 and the folded position configured for storage and transport. Advantageously, the folded position allows the seat cushion 100 to be readily stored in a purse or diaper bag, which can improve an overall ease of use.

In some embodiments, the cushion panel 102 can be biased toward the unfolded position. In such cases, the seat cushion 100 can include a fastener disposed on the cushion panel 102. For example, the cushion panel 102 can include corresponding snap features disposed on the bottom surface 120 of the first cushion panel 126 and the bottom surface 120 of the second cushion panel 128. Alternatively, the cushion panel 102 can include corresponding hook and loop fastener components on the bottom surface 120 of the first cushion panel 126 and the bottom surface 120 of the second cushion panel 128. The interior pad 104 can include embedded magnets (not shown) adjacent to the bottom surface 120 of the first cushion panel 126 and the bottom surface 120 of the second cushion panel 128. A skilled artisan can select other suitable fastening means, where desired, within the scope of the present disclosure.

As described herein, the seat cushion 100 can be particularly suited for use in a seat portion of a shopping cart 101. In conventional shopping carts 101, the seat portion often includes a platform 103 for a child to sit. The shopping cart 101 can include two leg holes 105 for the legs of the child. The leg holes 105 can be separated by a central bar 107. The central bar 107 can be configured to militate against the child sliding out of the leg holes 105, while sitting in the shopping cart 101. Accordingly, the cushion panel 102 can include a cut-out 136 formed in the first longitudinal side 108. The cut-out 136 can be configured to be disposed around the central bar 107 of the shopping cart 101. Advantageously, the cut-out 136 can allow the cushion panel 102 to extend across the platform 103 to an opening of each of the leg holes 105 without interference from the central bar 107.

As depicted in the embodiments shown in the drawings, the cut-out 136 can be semicircular in shape. The cut-out 136 can be formed substantially centrally (e.g., relative to the central axis) along the first longitudinal side 108. The semicircular cut-out 136 can act similar to the rounded corner 116 such that it militates against damage to the cushion panel 102 at the cut-out 136. A skilled artisan can select other suitable shapes for the cut-out 136 so long as the cut-out 136 can receive the central bar 107 of the shopping cart 101.

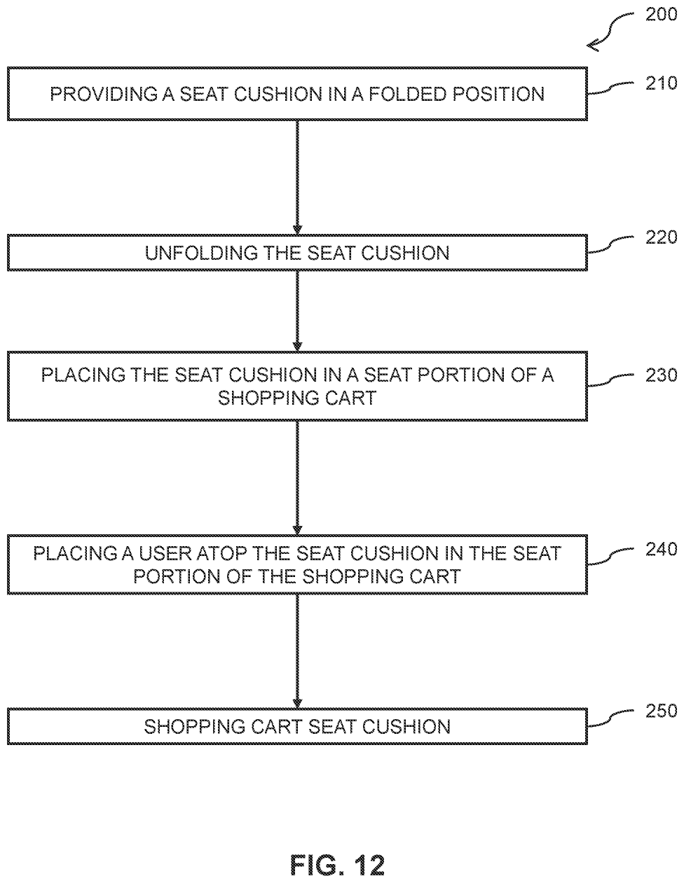

FIG. 12 is a flowchart of an example method 200 for using the seat cushion 100 of the present disclosure. The method 200 can include a step 210 of providing a seat cushion 100 as described herein. The seat cushion can be provided in the folded position. At step 220, the seat cushion 100 can be unfolded. At step 230, the seat cushion 100 can be placed in a seat portion 103 of a shopping cart 101. At step 240, a user can be placed atop the seat cushion 100 in the seat portion 103 of the shopping cart 101.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A seat cushion for a shopping cart, comprising:
a cushion panel configured to be disposed in a seat portion of the shopping cart, the cushion panel including:
an interior pad; and
a cover disposed on the interior pad,
wherein the cushion panel is selectively movable between a folded and an unfolded position.

2. The seat cushion of claim 1, wherein the cushion panel is defined by a first longitudinal side disposed parallel to a second longitudinal side that are connected by a third side and a fourth side.

3. The seat cushion of claim 2, wherein the cushion panel includes a semicircular cutout formed in the first longitudinal side.

4. The seat cushion of claim 2, wherein the first longitudinal side, the second longitudinal side, third side, and fourth side are connected via a top surface and a bottom surface, wherein the top surface is circumscribed by a top edge and the bottom surface is circumscribed by a bottom edge.

5. The seat cushion of claim 4, wherein the first longitudinal side, the second longitudinal side, third side, and fourth side taper along a height from the top surface to the bottom surface.

6. The seat cushion of claim 4, wherein the cushion panel is bisected along a central axis to form a first cushion panel and a second cushion panel.

7. The seat cushion of claim 6, wherein the first cushion panel and the second cushion panel are separated via a channel.

8. The seat cushion of claim 7, wherein each of the first cushion panel and the second cushion panel is foldable about the channel.

9. The seat cushion of claim 6, wherein a bottom surface of the first cushion panel abuts the bottom surface of the second cushion panel when the cushion panel is in the folded position.

10. The seat cushion of claim 7, wherein the channel is defined by a first angled wall of the first cushion panel and a second angled wall of the second cushion panel.

11. The seat cushion of claim 10, wherein the first angled wall is angled downwardly from the top edge to the central axis, and the second angled wall is disposed adjacent to the first angled wall and is angled downwardly from the top edge to the central axis.

12. The seat cushion of claim 7, wherein the channel has a depth of 6.5 mm and a width of 18 mm.

13. The seat cushion of claim 7, wherein the channel has a depth that is less than a height of the cushion panel.

14. The seat cushion of claim 1, wherein the cushion panel has a maximum length from about 10 inches to about 14 inches.

15. The seat cushion of claim 1, wherein the cushion panel has a maximum width from about 6 inches to about 8 inches.

16. The seat cushion of claim 1, wherein the cushion panel has a maximum length of 12 inches and a maximum width of 7 inches.

17. The seat cushion of claim 1, wherein the interior pad is fabricated from a foam material including polyurethane foam, ethylene-vinyl acetate foam, and combinations thereof.

18. The seat cushion of claim 1, wherein the cushion panel is defined by:
a first longitudinal side disposed parallel to a second longitudinal side that are connected by a third side and a fourth that are connected via a top surface and a bottom surface, the top surface is circumscribed by a top edge and the bottom surface is circumscribed by a bottom edge, each side tapers along a height from the top surface to the bottom surface, and the cushion panel includes a semicircular cutout formed in the first longitudinal side,
wherein the cushion panel is bisected along a central axis to form a first cushion panel and a second cushion panel that are separated by a channel, each of the first cushion panel and the second cushion panel is foldable about the channel, where a bottom surface of the first cushion panel abuts the bottom surface of the second cushion panel when the cushion panel is in the folded position,
wherein the channel is defined by a first angled wall of the first cushion panel and a second angled wall of the second cushion panel, the first angled wall is angled downwardly from the top edge to the central axis, and the second angled wall is disposed adjacent to the first angled wall and is angled downwardly from the top edge to the central axis, wherein the channel has a depth of 6.5 mm and a width of 18 mm and the depth that is less than a height of the cushion panel,
wherein the cushion panel has a maximum length from about 10 inches to about 14 inches and a maximum width from about 6 inches to about 8 inches.

19. A shopping cart seat cushion assembly, comprising:
a shopping cart having a seat portion; and
a seat cushion disposed in the seat portion, the seat cushion including:
a cushion panel, configured to be disposed in a seat portion of the shopping cart, the cushion panel including:
an interior pad; and
a cover disposed on the interior pad,
wherein the cushion panel is selectively movable between a folded and an unfolded position.

20. A method of using a shopping cart seat cushion, comprising:
providing a seat cushion including:
a cushion panel, configured to be disposed in a seat portion of the shopping cart, the cushion panel including:
an interior pad; and
a cover disposed on the interior pad,
wherein the cushion panel is in a folded position;
unfolding the seat cushion;
placing the seat cushion in a seat portion of a shopping cart; and
placing a user atop the seat cushion in the seat portion of the shopping cart.
